(19) United States
(12) Patent Application Publication
(10) Pub. No.: US 2026/0204733 A1
(43) Pub. Date: Jul. 16, 2026

(54) BATTERY AND METHOD FOR MANUFACTURING BATTERY

(71) Applicant: TOYOTA JIDOSHA KABUSHIKI KAISHA, Toyota-shi (JP)

(72) Inventors: Tetsuya WASEDA, Toyota-shi (JP); Hideyuki TOKIOKA, Toyota-shi (JP); Yuki SATO, Nagakute-shi (JP); Takuya MATSUYAMA, Miyoshi-shi (JP); Kenichi KAKISHITA, Nagoya-shi (JP); Takuya KIMURA, Toyota-shi (JP)

(73) Assignee: TOYOTA JIDOSHA KABUSHIKI KAISHA, Toyota-shi (JP)

(21) Appl. No.: 19/363,957

(22) Filed: Oct. 21, 2025

(30) Foreign Application Priority Data
Jan. 15, 2025 (JP) 2025-005776

(51) Int. Cl. H01M 50/46; H01M 4/02; H01M 4/36; H01M 4/38; H01M 4/66; H01M 10/0525; H01M 10/0585; H01M 50/449

(52) U.S. Cl. CPC H01M 50/461; H01M 4/366; H01M 4/386; H01M 4/667; H01M 10/0525; H01M 10/0585; H01M 50/449; H01M 2004/027

(57) ABSTRACT

A battery and a method for manufacturing the battery are provided. The battery includes: a first current collector layer; first electrode layers disposed on the first current collector layer; solid electrolyte layers each disposed on each of the first electrode layers on a side opposite to a side where the first current collector layer is disposed; second electrode layers each disposed on each of the solid electrolyte layers on a side opposite to a side where the first electrode layer is disposed; and second current collector layers each disposed on each of the second electrode layers on a side opposite to a side where the solid electrolyte layer is disposed. The second electrode layer contains an electrode active material and a solid electrolyte, and a content ratio of the solid electrolyte is higher on the solid electrolyte layer side than on the second current collector layer side.

### CROSS-REFERENCE TO RELATED APPLICATION

This application claims priority to Japanese Patent Application No. 2025-005776 filed on Jan. 15, 2025. The disclosure of the above-identified application, including the specification, drawings, and claims, is incorporated by reference herein in its entirety.

### BACKGROUND

### 1. Technical Field

The present disclosure relates to a battery and a method for manufacturing the battery.

### 2. Description of Related Art

Japanese Unexamined Patent Application Publication No. 2024-017879 (JP 2024-017879 A) discloses an active material composite particle that contains Si and a resin and has excellent cycle characteristics under low constraint. When a cross section of the composite resin is observed, the area ratio of the resin in a surface layer portion of the composite particle is higher than the area ratio of the resin in a central portion of the composite particle.

### SUMMARY

For batteries to be used under limited external pressure conditions, batteries manufactured by a pressing process under relatively low pressure, etc., it is desirable to improve adhesion between layers of an electrode laminate structure without means for increasing external pressure.

An object of one embodiment of the present disclosure is to provide a battery having excellent adhesion between a solid electrolyte layer and a layer adjacent to the solid electrolyte layer, and a method for manufacturing the battery.

Means for addressing the above issue includes the following aspects.

<1> A battery includes: a first current collector layer; a pair of first electrode layers disposed on one surface and the other surface of the first current collector layer; a pair of solid electrolyte layers each disposed on each of the first electrode layers on a side opposite to a side where the first current collector layer is disposed; a pair of second electrode layers each disposed on each of the solid electrolyte layers on a side opposite to a side where the first electrode layer is disposed; and a pair of second current collector layers each disposed on each of the second electrode layers on a side opposite to a side where the solid electrolyte layer is disposed. The second electrode layers each contain an electrode active material and a solid electrolyte, and a content ratio of the solid electrolyte is higher on the solid electrolyte layer side than on the second current collector layer side in a thickness direction.

<2> In the battery according to <1>, at least one of the second electrode layers includes a plurality of partial second electrode layers laminated in the thickness direction, and the content ratio of the solid electrolyte contained in each of the partial second electrode layers is higher in the partial second electrode layer disposed on the solid electrolyte layer side than in the partial second electrode layer disposed on the second current collector layer side.

<3> In the battery according to <1> or <2>, the first current collector layer is a cathode current collector layer, the first electrode layers are cathode layers, the second electrode layers are anode layers, and the second current collector layers are anode current collector layers.

<4> In the battery according to <3>, the anode layers each contain silicon as the electrode active material.

<5> A method for manufacturing the battery according to any one of <1> to <4> includes: pressing, in a thickness direction, a laminate including a pair of first electrode layers disposed on one surface and the other surface of a first current collector layer; disposing, by transfer using a transfer material including a substrate and a solid electrolyte layer containing a solid electrolyte, the solid electrolyte layer on each of the first electrode layers on a side opposite to a side where the first current collector layer is disposed; disposing, by transfer using a transfer material including a substrate and a first partial second electrode layer containing an electrode active material and a solid electrolyte, the first partial second electrode layer on each of a pair of the solid electrolyte layers on a side opposite to a side where the first electrode layer is disposed; and disposing, by transfer using a transfer material including a substrate and a second partial second electrode layer containing an electrode active material and a solid electrolyte, the second partial second electrode layer on each of a pair of the first partial second electrode layers on a side opposite to a side where the solid electrolyte layer is disposed. A content ratio of the solid electrolyte in the first partial second electrode layer is higher than a content ratio of the solid electrolyte in the second partial second electrode layer.

The one embodiment of the present disclosure provides the battery having excellent adhesion between the solid electrolyte layer and the layer adjacent to the solid electrolyte layer, and the method for manufacturing the battery.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a sectional view schematically showing a cross section of a battery cut along a thickness direction X of an electrode laminate structure; and

FIG. 2 is a sectional view schematically showing a cross section of a battery cut along the thickness direction X of the electrode laminate structure, with a second electrode layer including a plurality of layers.

### DETAILED DESCRIPTION OF EMBODIMENTS

In the present disclosure, a numerical range expressed using “to” refers to a range inclusive of the values before and after “to” as the lower limit value and the upper limit value, respectively.

In the present disclosure, “substantially symmetrical,” “substantially identical,” etc. include cases of “completely symmetrical,” “completely identical,” etc. and also include cases of “almost symmetrical,” “almost identical,” etc. with inevitable slight differences due to variations etc.

In the present disclosure, a combination of two or more preferred forms is a more preferred form.

In the present disclosure, the term “step” refers not only to an independent step but also includes a step that may not be clearly distinguishable from another step, as long as the intended purpose of the step is achieved.

In the present disclosure, when an embodiment is described with reference to the drawings, the configuration of the embodiment is not limited to the configuration illustrated in the drawings. The sizes of the members shown in the drawings are conceptual, and the relative sizes between the members are not limited thereto.

### Battery

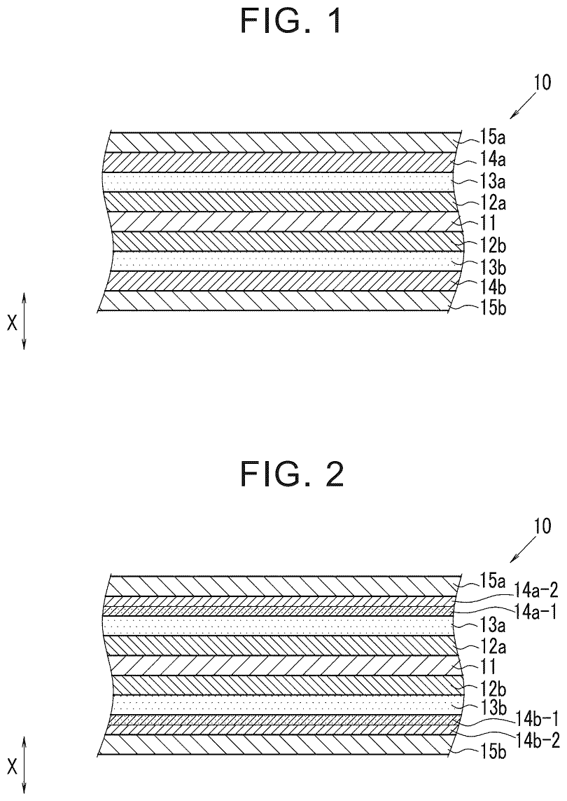

Hereinafter, a battery according to an embodiment of the present disclosure (hereinafter also referred to as “battery”) will be described with reference to FIGS. 1 and 2. The battery includes a first current collector layer, a pair of first electrode layers, a pair of solid electrolyte layers, a pair of second electrode layers, and a pair of second current collector layers. The first electrode layers are disposed on one surface and the other surface of the first current collector layer. The solid electrolyte layers are each disposed on each of the first electrode layers on a side opposite to the side where the first current collector layer is disposed. The second electrode layers are each disposed on each of the solid electrolyte layers on a side opposite to the side where the first electrode layer is disposed. The second current collector layers are each disposed on each of the second electrode layers on a side opposite to the side where the solid electrolyte layer is disposed. The second electrode layer contains an electrode active material and a solid electrolyte, and the content ratio of the solid electrolyte is higher on the solid electrolyte layer side than on the second current collector layer side.

It is known that, in solid-state batteries, expansion and contraction occur in the electrode active material during charging and discharging. The expansion and contraction of the electrode active material cause expansion and contraction of the electrode layer that may result in breakdown of the electrode layer or interfacial peeling in which contact between the electrode layer and the adjacent solid electrolyte layer is lost, leading to a decrease in battery performance such as cycle characteristics. Depending on the type of the electrode active material, low constraint pressure conditions such as limited external pressure conditions, control for limiting the pressing pressure during production, etc. may be necessary. For example, when an electrode layer on the outer side of an electrode laminate structure is formed by transfer during formation of a monopolar electrode, the electrode layer may be prone to peeling. Even in such a case, it is desirable to use a method other than means for increasing external pressure to ensure adhesion between layers of the battery laminate structure and improve the battery performance such as cycle characteristics.

The inventors have investigated ways to improve the adhesion between layers of the electrode laminate structure and improve the battery performance such as cycle characteristics without the means for increasing external pressure. The inventors have focused on suppressing the interfacial peeling between the solid electrolyte layer and the electrode layer adjacent to the solid electrolyte layer in the battery laminate structure, and found that the peeling between the solid electrolyte layer and the electrode layer adjacent to the solid electrolyte can be suppressed when the content ratio of the solid electrolyte in the electrode layer is higher on the solid electrolyte layer side than on the current collector layer side.

Although the mechanism to achieve the above effect is not clear, it is presumed that, when the content ratio of the solid electrolyte in the electrode layer is higher on the solid electrolyte layer side than on the current collector layer side, the elasticity and gap-filling ability of the interface between the two layers are enhanced in the region of the electrode layer closer to the solid electrolyte layer, and local deformation during transfer, pressing, etc. is absorbed more easily, thereby increasing the adhesion. It is presumed that this results in stronger adhesion of the contact surfaces at the interface between the electrode layer and the solid electrolyte layer, thereby stabilizing the electrical and mechanical connection. It is therefore presumed that the interfacial peeling between the electrode layer and the solid electrolyte layer is suppressed and the cycle characteristics are improved.

As shown in FIG. 1, an electrode cell 10 in a battery has an electrode laminate structure including a first current collector layer 11, a first electrode layer 12, a solid electrolyte layer 13, a second electrode layer 14, and a second current collector layer 15. The first electrode layer 12 includes a pair of a first electrode layer 12a and a first electrode layer 12b. The solid electrolyte layer 13 includes a pair of a solid electrolyte layer 13a and a solid electrolyte layer 13b. The second electrode layer 14 includes a pair of a second electrode layer 14a and a second electrode layer 14b. The second current collector layer 15 includes a pair of a second current collector layer 15a and a second current collector layer 15b. In the electrode cell 10, the second current collector layer 15b, the second electrode layer 14b, the solid electrolyte layer 13b, the first electrode layer 12b, the first current collector layer 11, the first electrode layer 12a, the solid electrolyte layer 13a, the second electrode layer 14a, and the second current collector layer 15a are disposed in this order in a thickness direction X. When the first electrode layer 12a and the first electrode layer 12b are not distinguished from each other, the term “first electrode layer 12” is used. When the solid electrolyte layer 13a and the solid electrolyte layer 13b are not distinguished from each other, the term “solid electrolyte layer 13” is used. When the second electrode layer 14a and the second electrode layer 14b are not distinguished from each other, the term “second electrode layer 14” is used. When the second current collector layer 15a and the second current collector layer 15b are not distinguished from each other, the term “second current collector layer 15” is used.

The thickness direction X refers to a thickness direction of each layer constituting the electrode laminate structure, and is also a lamination axis direction. The electrode cell 10 has a monopolar electrode structure having a layer configuration symmetrical in the thickness direction X with the first current collector layer 11 at the center.

The second electrode layer 14 contains an electrode active material and a solid electrolyte, and the content ratio of the solid electrolyte is higher on the solid electrolyte layer 13 side than on the second current collector layer 15 side. The content of the solid electrolyte in the second electrode layer 14 means the content on a volume basis. Therefore, the volume of the solid electrolyte in the volume of a predetermined region of the second electrode layer 14 on the solid electrolyte layer 13 side is larger than the volume of the solid electrolyte in the volume of a predetermined region of the second electrode layer 14 on the second current collector layer 15 side.

Depending on the type of the battery, the type of the solid electrolyte, etc., for example, the volume of the solid electrolyte in the volume of the predetermined region of the second electrode layer 14 on the solid electrolyte layer 13 side is preferably more than 20 vol % and more preferably 40 vol % or more with respect to the total volume of the predetermined region of the second electrode layer 14 on the solid electrolyte layer 13 side from the viewpoint of cycle characteristics. The upper limit is preferably less than 80 vol % and more preferably 60 vol % or less. The volume of the solid electrolyte in the volume of the predetermined region of the second electrode layer 14 on the second current collector layer 15 side may be smaller than the volume of the solid electrolyte in the volume of the predetermined region of the second electrode layer 14 on the solid electrolyte layer 13 side.

By setting the content ratio of the solid electrolyte on the solid electrolyte layer 13 side within the above range, breakdown occurring in the second electrode layer 14 under load conditions in a cycle test etc. tends to be bulk breakdown within the layer, and interfacial peeling and interfacial breakdown tend to occur at the interface. By setting the content ratio of the solid electrolyte on the solid electrolyte layer 13 side outside the above range, breakdown occurring in the second electrode layer 14 under load conditions in a cycle test etc. tends to be interfacial peeling, interfacial breakdown, etc. at the interface. Therefore, when the content ratio of the solid electrolyte in the second electrode layer is higher on the solid electrolyte layer side than on the second current collector layer side, the adhesion between the layers is improved, the interfacial peeling between the solid electrolyte layer and the second electrode layer is suppressed, and the cycle characteristics are improved.

The content ratio of the solid electrolyte in the second electrode layer 14 may be compared under the assumption that the volume of the predetermined region on the solid electrolyte layer 13 side and the volume of the predetermined region on the second current collector layer 15 side are the same. For example, the comparison may be made in such a manner that the second electrode layer 14 is equally divided in the thickness direction X into a plurality of partial second electrode layers, namely a partial second electrode layer disposed on the solid electrolyte layer 13 side and a partial second electrode layer disposed on the second current collector layer 15 side, and the ratios of the volumes of the solid electrolytes in the total volumes of the partial second electrode layers are calculated. That is, the partial second electrode layers may be regarded as the predetermined regions of the second electrode layer 14.

There is no limitation on the means for setting the content ratio of the solid electrolyte to be higher on one surface side, namely the solid electrolyte layer 13 side, than on the other surface side, namely the second current collector layer 15 side, in the second electrode layer 14. For example, the second electrode layer 14 may have a laminate structure including a plurality of partial second electrode layers in the thickness direction X, and the content ratios of the solid electrolytes may be varied in the partial second electrode layers.

From the viewpoint of appropriate control on the content ratio of the solid electrolyte, it is preferable that at least one of the second electrode layers 14 include a plurality of partial second electrode layers laminated in the thickness direction, and the content ratio of the solid electrolyte contained in each of the partial second electrode layers be higher in the first partial second electrode layer disposed on the solid electrolyte layer 13 side than in the second partial second electrode layer disposed on the second current collector layer 15 side. When the first partial second electrode layer and the second partial second electrode layer are not distinguished from each other, the term “partial second electrode layer” is used. The number of partial second electrode layers may be two or more, and is preferably two from the viewpoint of cycle characteristics.

As shown in FIG. 2, the second electrode layer 14a out of the pair of second electrode layers 14 in the battery includes a first partial second electrode layer 14a-1 and a second partial second electrode layer 14a-2, and the second electrode layer 14b includes a first partial second electrode layer 14b-1 and a second partial second electrode layer 14b-2. The content ratio of the solid electrolyte in the first partial second electrode layer 14a-1 is higher than the content ratio of the solid electrolyte in the second partial second electrode layer 14a-2. The content ratio of the solid electrolyte in the first partial second electrode layer 14b-1 is higher than the content ratio of the solid electrolyte in the second partial second electrode layer 14b-2.

There is no limitation on the means for varying the content ratios of the solid electrolytes in the partial second electrode layers. The content ratio of the solid electrolyte may mean the content ratio of the solid electrolyte material contained in the solid electrolyte. For example, various means can be employed, such as a method in which the same type of solid electrolyte having the same particle size and the same content ratio of the solid electrolyte material is contained in each of the partial second electrode layers while varying the contents in the partial second electrode layers, a method in which solid electrolytes having the same content ratio of the solid electrolyte material but different particle sizes are contained in corresponding partial second electrode layers, and a method in which solid electrolyte particles having the same particle size but different content ratios of the solid electrolyte material are contained in corresponding partial second electrode layers.

At least one of the second electrode layers 14 may include a plurality of partial second electrode layers laminated in the thickness direction with different content ratios of the solid electrolytes. From the viewpoint of cycle characteristics, it is preferable that each of the second electrode layers 14 include a plurality of partial second electrode layers laminated in the thickness direction. In this case, in the partial second electrode layers of the second electrode layers 14, the content ratios of the solid electrolytes in the two partial second electrode layers disposed at positions closer to the solid electrolyte layers 13 may be the same or different. From the viewpoint of cycle characteristics, it is preferable that the content ratios be the same. That is, it is preferable that the content ratios of the solid electrolytes in the partial second electrode layers be substantially symmetrical with respect to the solid electrolyte layers 13. For example, it is preferable that, in the partial second electrode layers of the second electrode layers 14, the content ratios of the solid electrolytes in the first partial second electrode layer 14a-1 and the first partial second electrode layer 14b-1 disposed at positions closer to the solid electrolyte layers 13 be substantially the same and the content ratios of the solid electrolytes in the second partial second electrode layer 14a-2 and the second partial second electrode layer 14b-2 disposed at positions closer to the second current collector layers 15 be substantially the same.

It is preferable that the content ratio of the electrode active material in the second electrode layer 14 be the same throughout the second electrode layer 14. That is, it is preferable that the content ratios of the electrode active materials in the partial second electrode layers be substantially the same. For example, it is preferable that the content ratios of the electrode active materials be the same in the first partial second electrode layer 14a-1, the first partial second electrode layer 14b-1, the second partial second electrode layer 14a-2, and the second partial second electrode layer 14b-2. The content ratio of the electrode active material is on a volume basis.

The first electrode layer 12 may contain an electrode active material and a solid electrolyte, and the content ratio of the solid electrolyte in the first electrode layer 12 may be higher on the solid electrolyte layer side than on the first current collector layer side. The content ratio of the solid electrolyte may be higher on the solid electrolyte layer side in either the first electrode layer 12 or the second electrode layer 14. The content ratio of the solid electrolyte may be higher on the solid electrolyte layer side in both the first electrode layer 12 and the second electrode layer 14.

In the present disclosure, the first electrode layer 12 and the second electrode layer 14 may be referred to as “electrode layers” without distinction, and the first current collector layer 11 and the second current collector layer 15 may be referred to as “current collectors” without distinction. Since the content ratio of the solid electrolyte in the electrode layer is higher on the solid electrolyte layer side than on the current collector layer side, the interfacial peeling between the electrode layer and the solid electrolyte layer is suppressed and the cycle characteristics are improved in the battery.

In the battery, when the first electrode layer is an anode layer, the second electrode layer is a cathode layer, and when the first electrode layer is a cathode layer, the second electrode layer is an anode layer. In the battery according to the embodiment of the present disclosure, when the first current collector layer is an anode current collector layer, the second current collector layer is a cathode current collector layer, and when the first current collector layer is a cathode current collector layer, the second current collector layer is an anode current collector layer.

In the battery, the second electrode layer may be either of the anode layer and the cathode layer. When the content ratio of the solid electrolyte in the anode layer is higher on the solid electrolyte layer side than on the current collector layer side, the effect of improving the cycle characteristics is more remarkable. Therefore, the second electrode layer is preferably the anode layer. When the second electrode layer is the anode layer, it is preferable that the first current collector layer be the cathode current collector layer, the first electrode layer be the cathode layer, and the second current collector layer be the anode current collector layer.

### Members Constituting Battery

As the current collector layer including the first current collector layer, the second current collector layer, etc., for example, an aluminum foil, a copper foil, a nickel foil, a titanium foil, or a stainless steel foil can be used. The thickness of the current collector layer may be, for example, 1 μm to 100 μm. The thickness of each layer such as the current collector layer is an average of values measured at 10 points selected as appropriate.

It is preferable that one of the first electrode layer and the second electrode layer be a cathode layer containing a cathode active material and the other be an anode layer containing an anode active material. The cathode layer contains a cathode active material that can store and release charge carriers such as lithium ions. As the cathode active material, any material available as a cathode active material for lithium ion secondary batteries may be used, such as a lithium composite metal oxide having a layered rock salt structure, a metal oxide having a spinel structure, or a polyanion compound. Two or more kinds of cathode active material may be used in combination. Specifically, the cathode layer may contain olivine lithium iron phosphate (LiFePO₄) as a composite oxide.

The anode layer can be made of any element, alloy, or compound that can store and release charge carriers such as lithium ions, without any particular limitations. Examples of the anode active material include lithium (Li), carbon, a metal compound, an element that can be alloyed with lithium, and a compound thereof. Examples of carbon include natural graphite, artificial graphite, hard carbon (hardly graphitizable carbon), and soft carbon (easily graphitizable carbon). Examples of artificial graphite include highly oriented graphite and mesocarbon microbeads. Examples of the element that can be alloyed with lithium include silicon and tin. In the present embodiment, the anode active material layer contains graphite as a carbon-based material. To exhibit more remarkably the effect of improving the cycle characteristics, the anode layer preferably contains silicon as the electrode active material.

Each of the cathode active material layer and the anode active material layer may further contain a conductive aid for increasing electrical conductivity, a binder, an electrolyte (polymer matrix, ion-conductive polymer, electrolyte solution, etc.), an electrolyte supporting salt (lithium salt) for increasing ion conductivity, etc. The components contained in the cathode layer and the anode layer, or the blending ratio of the components, and the thicknesses of the cathode layer and the anode layer are not particularly limited, and public knowledge about lithium ion secondary batteries can be referred to as appropriate. The thickness of each of the cathode layer and the anode layer is, for example, 2 μm to 150 μm.

To form the cathode layer or the anode layer on the surface of the current collector layer, a known method such as a roll coating method may be used. To improve the thermal stability of the cathode layer or the anode layer, a heat-resistant layer may be provided on the surface (one or both sides) of the current collector layer or on the surface of the cathode layer or the anode layer. The heat-resistant layer contains, for example, inorganic particles and a binder, and may also contain additives such as a thickener.

The conductive aid is added to increase the electrical conductivity of the cathode layer or the anode layer. The conductive aid is, for example, acetylene black, carbon black, or graphite.

Examples of the binder include fluorine-containing resins such as polyvinylidene fluoride, polytetrafluoroethylene, and fluorine rubber, thermoplastic resins such as polypropylene and polyethylene, imide resins such as polyimide and polyamide-imide, alkoxy silyl group-containing resins, acrylic resins such as poly(meth)acrylic acid, styrene butadiene rubber (SBR), carboxymethyl cellulose, alginates such as sodium alginate and ammonium alginate, water-soluble cellulose ester crosslinked bodies, and starch-acrylic acid graft polymers. These binders may be used alone or in combination. The solvent may be, for example, water or N-methyl-2-pyrrolidone (NMP).

In the solid electrolyte layer used in the battery, the type of the solid electrolyte contained in the electrolyte layer is not particularly limited. For example, the solid electrolyte may be selected from the solid electrolytes that may be contained in the electrode layer described above. The first electrode layer and the second electrode layer may each contain the solid electrolyte. In this case, the types of the solid electrolytes contained in the layers may be the same or different.

When the battery contains the solid electrolyte, it may contain, together with the solid electrolyte, an electrolyte solution in an amount of less than 10 mass % with respect to the total amount of the electrolyte. When the battery of the present disclosure contains the solid electrolyte, the solid electrolyte may be a composite solid electrolyte containing both an inorganic solid electrolyte and a polymer electrolyte. The solid electrolyte layer may have a single-layer structure or a multi-layer structure. The multi-layer structure may include, for example, an adhesive layer, a ceramic layer serving as a heat-resistant layer, etc. The solid electrolyte layer 13 may be impregnated with an electrolyte, or the solid electrolyte layer itself may be composed of an electrolyte such as a polymer electrolyte or an inorganic electrolyte.

### Method for Manufacturing Battery

A battery manufacturing method according to one embodiment of the present disclosure (hereinafter also referred to as “battery manufacturing method”) is a method for manufacturing the battery described above. With the battery manufacturing method, it is possible to manufacture the battery having the above configuration in a preferable manner in terms of quality, efficiency, etc. Each layer of the electrode laminate structure included in the battery is the same as that described above.

The battery manufacturing method includes a lamination and densification step, and a transfer step for each layer. The lamination and densification step includes pressing, in the thickness direction, a laminate in which a pair of first electrode layers is disposed on one surface and the other surface of a first current collector layer. The thickness direction X is the lamination axis direction (see FIG. 1). The transfer step includes disposing solid electrolytes by transfer, disposing first partial second electrode layers by transfer, and disposing second partial second electrode layers by transfer.

### Lamination and Densification Step

The lamination and densification step includes a densification step of pressing, in the thickness direction, a laminate prepared by disposing a pair of first electrode layers on one surface and the other surface of a first current collector layer. There is no limitation on the method for disposing the first electrode layers on one surface and the other surface of the first current collector layer. The first electrode layers may be disposed by applying slurries that are materials of the first electrode layers on both surfaces of the first current collector. The densification step may be a step of densifying the first electrode layers by pressing, in the thickness direction, the laminate including the first current collector layer and the two first electrode layers. For example, the laminate having a three-layer configuration of first electrode layer/first current collector layer/first electrode layer may be densified by pressing with a roll press. The densification conditions may be a linear pressure of 2.0 t/cm to 10.0 t/cm and a heating temperature of 40° C. to 180° C. In the disclosure, the linear pressure can be a value measured by the following expression (1) in the linear pressure applied by the roll press.

$$Linear pressure ( t / cm ) = roll thrust ( t ) \div ( workplace width \times flow direction crushing allowance ) ( cm ) \qquad ( 1 )$$

### Transfer Step

The transfer step subsequent to the lamination and densification step includes performing a transfer step for solid electrolyte layers, a transfer step for first partial second electrode layers, and a transfer step for second partial second electrode layers in this order. In the transfer step, each layer is disposed by transfer, that is, by a transfer method using a transfer material. In each of the transfer steps, a transfer material prepared in advance is used. Each transfer material includes a substrate. A known substrate can be used as the substrate. Each transfer material is formed by disposing the material of each layer onto the substrate. The method for disposing each layer on the substrate in each transfer material is not limited, and may be applying the material for forming each layer.

In each transfer step, it is preferable to perform pressing after the transfer from the viewpoint of satisfactorily joining each layer to be transferred. The pressing conditions may be a linear pressure of 0.2 t/cm or more and 4.0 t/cm or less and a heating temperature of 40° C. to 180° C. Depending on the transfer step for disposing each layer, the pressing conditions may be substantially the same or different.

The transfer step for solid electrolyte layers includes disposing, by transfer using a transfer material including a substrate and the solid electrolyte layer containing a solid electrolyte, the solid electrolyte layer on each of the first electrode layers of the electrode laminate structure having a three-layer configuration of first electrode layer/first current collector layer/first electrode layer, including the first current collector layer and the first electrode layers, on the side opposite to the side where the first current collector is disposed. In the transfer step for solid electrolyte layers, one solid electrolyte layer is disposed on the surface of each of the first electrode layers. Therefore, two solid electrolyte layers 13, namely the solid electrolyte layer 13a and the solid electrolyte layer 13b (see FIG. 2), are disposed in one electrode cell 10 (see FIG. 2).

In the transfer step for first partial second electrode layers, the first partial second electrode layer is disposed on each of the solid electrolyte layers of the electrode laminate structure having a five-layer configuration of solid electrolyte layer/first electrode layer/first current collector layer/first electrode layer/solid electrolyte layer on the side opposite to the side where the first electrode layer is disposed. In the transfer step for first partial second electrode layers, one first partial second electrode layer is disposed on the surface of each of the solid electrolyte layers. Therefore, two first partial second electrode layers, namely the first partial second electrode layer 14a-1 and the first partial second electrode layer 14b-1 (see FIG. 2), are disposed in one electrode cell 10 (see FIG. 2).

The transfer step for second partial second electrode layers includes disposing, by transfer using a transfer material including a substrate and the second partial second electrode layer containing an electrode active material and a solid electrolyte, the second partial second electrode layer on each of the first partial second electrode layers of the electrode laminate structure having a seven-layer configuration of first partial second electrode layer/solid electrolyte layer/first electrode layer/first current collector layer/first electrode layer/solid electrolyte layer/first partial second electrode layer on the side opposite to the side where the first electrode layer is disposed. In the transfer step for second partial second electrode layers, one second partial second electrode layer is disposed on the surface of each of the first partial second electrode layers. Therefore, two second partial second electrode layers, namely the second partial second electrode layer 14a-2 and the second partial second electrode layer 14b-2 (see FIG. 2), are disposed in one electrode cell 10 (see FIG. 2).

The content ratio of the solid electrolyte in the first partial second electrode layer is higher than the content ratio of the solid electrolyte in the second partial second electrode layer. The content ratios of the solid electrolytes in the first partial second electrode layer and the second partial second electrode layer, etc. are the same as those described above.

### Type and Application of Battery

The type of the battery is not particularly limited, but is typically a lithium ion battery. The battery according to the embodiment of the present disclosure may be either of a primary battery and a secondary battery, but is preferably a secondary battery because the effect of improving the cycle characteristics is more remarkable. The battery is not limited to the lithium ion battery, and may be any of various secondary batteries such as a semi-solid-state battery including a gel layer containing an electrolyte solution and a polymer between an electrode and a solid electrolyte, an all-solid-state battery using a solid electrolyte as an electrolyte, a lead-acid battery, a nickel-cadmium battery, and a nickel metal hydride battery. The solid electrolyte may contain an electrolyte solution in an amount of less than 10 mass % with respect to the total amount of the electrolyte. The battery is not limited to the secondary battery, and may be a primary battery such as a manganese dry battery, a lithium fluoride graphite primary battery, or a manganese dioxide lithium primary battery. The battery is preferably a semi-solid-state battery or an all-solid-state battery, and more preferably an all-solid-state battery.

The battery is applied to, for example, a power supply for vehicles such as a hybrid electric vehicle, a plug-in hybrid electric vehicle, a battery electric vehicle, a gasoline automobile, and a diesel automobile. In particular, the battery is preferably used as a power supply for driving a hybrid electric vehicle, a plug-in hybrid electric vehicle, or a battery electric vehicle. The solid-state battery according to the present disclosure may be used as a power supply for moving bodies other than vehicles (e.g., trains, ships, and aircraft), or may be used as a power supply for electrical products such as information processing devices.

The present disclosure is not limited to the above embodiment. The above embodiment is illustrative, and anything having substantially the same configuration as, and having similar functions and effects to, the technical idea described in the claims of the present disclosure is included in the technical scope of the present disclosure.

What is claimed is:

1. A battery comprising:
a first current collector layer;
a pair of first electrode layers disposed on one surface and the other surface of the first current collector layer;
a pair of solid electrolyte layers each disposed on each of the first electrode layers on a side opposite to a side where the first current collector layer is disposed;
a pair of second electrode layers each disposed on each of the solid electrolyte layers on a side opposite to a side where the first electrode layer is disposed; and
a pair of second current collector layers each disposed on each of the second electrode layers on a side opposite to a side where the solid electrolyte layer is disposed, wherein
the second electrode layers each contain an electrode active material and a solid electrolyte, and a content ratio of the solid electrolyte is higher on the solid electrolyte layer side than on the second current collector layer side in a thickness direction.

2. The battery according to claim 1, wherein:
at least one of the second electrode layers includes a plurality of partial second electrode layers laminated in the thickness direction; and
the content ratio of the solid electrolyte contained in each of the partial second electrode layers is higher in the partial second electrode layer disposed on the solid electrolyte layer side than in the partial second electrode layer disposed on the second current collector layer side.

3. The battery according to claim 1, wherein:
the first current collector layer is a cathode current collector layer;
the first electrode layers are cathode layers;
the second electrode layers are anode layers; and
the second current collector layers are anode current collector layers.

4. The battery according to claim 3, wherein the anode layers each contain silicon as the electrode active material.

5. A method for manufacturing the battery according to claim 1, the method comprising:
pressing, in a thickness direction, a laminate including a pair of first electrode layers disposed on one surface and the other surface of a first current collector layer;
disposing, by transfer using a transfer material including a substrate and a solid electrolyte layer containing a solid electrolyte, the solid electrolyte layer on each of the first electrode layers on a side opposite to a side where the first current collector layer is disposed;
disposing, by transfer using a transfer material including a substrate and a first partial second electrode layer containing an electrode active material and a solid electrolyte, the first partial second electrode layer on each of a pair of the solid electrolyte layers on a side opposite to a side where the first electrode layer is disposed; and
disposing, by transfer using a transfer material including a substrate and a second partial second electrode layer containing an electrode active material and a solid electrolyte, the second partial second electrode layer on each of a pair of the first partial second electrode layers on a side opposite to a side where the solid electrolyte layer is disposed, wherein
a content ratio of the solid electrolyte in the first partial second electrode layer is higher than a content ratio of the solid electrolyte in the second partial second electrode layer.
